(19) United States
(12) Patent Application Publication
(10) Pub. No.: US 2017/0277700 A1
(43) Pub. Date: Sep. 28, 2017

(54) Method for Incident Video and Audio Association

(71) Applicant: Utility Associates, Inc., Decatur, GA (US)

(72) Inventors: Ted Michael Davis, Decatur, GA (US); Robert Stewart McKeeman, Atlanta, GA (US); Simon Araya, Decatur, GA (US)

(21) Appl. No.: 15/470,376

(22) Filed: Mar. 27, 2017

Related U.S. Application Data
(60) Provisional application No. 62/313,774, filed on Mar. 27, 2016.

(51) Int. Cl. G06F 17/30; G06K 9/00; G11B 27/10

(52) U.S. Cl. CPC G06F 17/3082; G11B 27/10; G06K 9/00771; G06K 9/00677; G06K 9/00791; G06K 9/00671; G06K 9/00288; G06F 17/30817; G06K 2209/15; G06K 2209/27

(57) ABSTRACT

This invention is a method of capturing and analyzing video, image, audio, LPR, and other metadata to identify all evidence artifacts that are related to an Incident or Event.

### CROSS-REFERENCE TO RELATED APPLICATIONS

This application claims priority to U.S. Provisional Application No. 62/313,774, filed Mar. 27, 2016, the contents of which are expressly incorporated herein by reference in its entirety.

### TECHNICAL FIELD

The present invention is in the technical field of a method of associating video, image, audio, License Plate Recognition (LPR), facial recognition, and metadata recorded by various personal recording devices, such as personal cameras, wireless microphones, in-vehicle video recorders, and other video recorders that may be related to a Public Safety or other type of Incident.

### BACKGROUND OF THE INVENTION

More particularly, the present invention is in the technical field of using metadata including location, date/time, case number, officer ID number, vehicle ID number, personal camera ID number, Incident number, license plate numbers, facial recognition results, key words, and other metadata to automatically associate multiple video, audio, and/or metadata recordings and artifacts to an Incident or an Event. Once one video, audio, or metadata artifact related to an Incident is identified, all other video, audio, and/or metadata artifacts also related to an Incident need to be identified so that a total view of all evidence and facts related to an Incident is provided. These other associated videos, audio recordings, and other metadata event artifacts such as light bar turned on, vehicle braking, siren turned on, vehicle door open, license plate number, facial recognition, et al can be selected to be displayed or played as a video administrator, police officer, prosecutor, defense attorney, manager, or other system user may choose.

This need is not limited to a law enforcement use case. Use cases exist in the electric and gas utilities industry for storm damage assessment, system restoration, preventive maintenance, tort defense, training, and other business needs. Another use case is in the public transportation industry, where multiple video views, audio sources, and vehicle and operator metadata events can be used for Incident analysis, training, tort defense, and customer service support. Use cases exist in a variety of industries where an industry participant has vehicles and field workers interacting performing work and interacting with the public, where there is always a challenge for safe, efficient, and effective service delivery, and risk of tort liability.

In the past with recording devices that only stream or record analog video and audio data, it typically was not possible to embed date/time, location, and other metadata within the analog video and audio data. Typically video and audio was transmitted as an analog data stream much like an analog television broadcast, where the video and audio could be viewed in real time, but there was no mechanism to store the analog data stream. Subsequently video recording devices such as VHS cassette recorders used magnetic tape cartridges to capture/intercept the live analog data stream and record the analog data, or “burn” the analog data stream to CD-ROM or DVD data disks. However, there was no ability to also capture metadata such as location and date/time as digital metadata. In some instances it was possible to overlay an image of a recording date/time on the video itself, obscuring and modifying the pixels of the video behind the area where the date/time stamp was displayed, typically in the bottom right or top right corner of the video image. However, while this recording date/time overlay stamp could be seen by the viewer, these analog video pixels were not stored in any kind of machine readable format that could be accessed by computer software to perform searches or synchronize playback with video and audio from other sources.

Furthermore, the date/time overlay pixels were only as accurate as the date/time clock used to generate the date/time pixel overlay image. In many cases where a video recorder time was not set correctly (in many cases the video recorder time was never set, and the date Jan. 1, 1980 and time of 12:00 am was perpetually flashing on the video recorder control display screen), there was no assurance that the date and time pixels displayed on the video was in fact the correct date and time of when the video was actually recorded.

In very rare circumstances a video recording device included a GPS location capture device, and could also overlay a portion of the video screen with pixels displaying the device location

Latitude and Longitude. These GeoLocation pixels of course obscure the video pixels behind the video display area where the Latitude and Longitude value pixels are stamped, so there is information loss and the captured video has been modified. As with date/time stamp overlays, these analog Latitude and Longitude pixels were not stored in any kind of machine-readable format on the analog tape where a computer software program could perform searches against video location metadata.

So in almost all cases it is impossible to search analog video and audio streams or recordings for video, audio, and metadata by date/time, location, or other metadata search criteria. External data such as a label on a VHS tape case was typically the only metadata available, if any metadata was available. Typically this tape case metadata was limited, not consistent, hand written on a label with a Sharpie, and suffers from frequent human error and the quality of the individual handwriting. Other than rummaging through tapes and disks stored in a police department evidence storage room, or scanning through evidence entry logbooks, there was no way to do any kind of search for other video, audio, or metadata that might be related to an Incident. Any searching was prone to human error, even if the Date/Time and or

Location data was accurately recorded on an evidence storage room entry logbook or on the label on the VHS cassette case or the CD-ROM or DVD disk itself.

Fortunately video and audio data has migrated to being recorded in digital format in various standard formats such as H.263, H.264, .mp4, .AVI, and a variety of other video and audio recording standard formats. However, typically these generic video and audio digital data recording formats do not support metadata such as recording date/time or GPS location. Certainly these protocols and standards do not support expanded custom metadata such as light bar on, siren on, brakes engaged, patrol car door open, power take-off operating, bucket boom docked in cradle, and an almost infinite variety of other metadata that would be useful to have in industry specific uses cases to support safe, efficient, and effective field operations.

However, it is possible to implement enhanced video recording data formats that can include a variety of metadata artifacts that include accurate with certainty date/time and location from a GPS receiver integrated into the recording device, and further integrated with sensors such as accelerometers; Near Field Communications; hardwire or wireless connections to physical assets as car door switches, light bar, siren, weapons rack, Power Take-off, Utility bucket truck boom cradle status; Bluetooth devices such as wristbands with heart rate and temperature sensors; Zigbee asset tag controllers that provide the unique asset tag ID and RSSI value that indicates distance from the vehicle; connection to vehicle On-Board Diagnostic (OBD) and JBus parameter data from vehicle computer such as vehicle ID, engine RPM, seat belt status, power voltage, and engine diagnostic parameter and trouble code values; and a variety of other metadata originating from a vehicle, a personal camera, a fixed location video camera, or any other kind of sensor or asset that is communicating on a real-time basis with a vehicle or personal camera, to a vehicle area network processor, an enterprise database application or server, or to an internet cloud-based repository on an Internet of Things basis.

Furthermore, a personal, In-Car, or fixed location video camera can transmit a key-frame image of one or more persons of interest to a central facial recognition process or server to identify a possible suspect. Knowledge of a possible suspect's criminal record and outstanding warrants can aid police officers in determining how to approach and deal with suspects, and to understand what elevated risk profiles they may face. Identifying one suspect can also lead to identification of known associates who may also be involved in an Incident, and provide further clarity to police officers about possible threats and risk profiles they face as they deal with an Incident.

Once this metadata is collected and associated with video and audio data on a real-time synchronized basis, this wide variety of metadata can also be searched and used to identify relationships and associations with other video and audio recording data that might be associated with an Incident.

Personal cameras worn by police officers can record video, pictures, audio, and time/date, location, GPS events such as distance traveled, speed, a turn of more than x degrees, starts, stops, accelerometer velocity and motion, other sensor events, NFC message reads, text entry and voice recognition Notes entered on the personal video camera device, selection of one or more Incident type classifications, remote assignment of Incident case numbers received from

Computer-Aided Dispatching and other work management applications communicating on a real-time and batch basis with application software running on the personal camera, Incident ID numbers auto- generated by the personal camera, GeoFence zone boundaries and identification numbers transmitted to the personal camera by video management and location control and display applications, identification of suspect identity through facial recognition processes and algorithms, and other metadata artifacts that are useful to document facts related to a public safety Incident.

There are increasing calls for all police officers to wear personal cameras while on duty. Police cars and other vehicles have long had In-Car Video Recording devices and License

Plate Recognition systems that capture video, audio, license plate number, location, date/time, and other metadata as part of a system used to collect and document facts related to a public safety incident. Police departments, Cities, Counties, and other government agencies, businesses, and private individuals also have fixed location video, audio, and License Plate Recognition recording systems that record video, audio, vehicle ID, and date/time metadata, with location already known since the camera is permanently installed in a fixed location—on the side of a building, on a pole, or other fixed location. Typically Memorandums of Understanding (MOU) are used to define the relationships between owners of mobile and fixed location video, audio, and metadata recording devices and various other entities such a Police Department Video Integration Centers who desire to have live streaming access to the video, audio, and metadata. An MOU can further define access and storage rights around whether the recipient of the video, audio, and/or metadata artifact stream has view only rights, or also has a right to record and retain the artifacts provided by the recording device owner.

Therefore, given that it is possible to include a wide variety of metadata around video and audio data from a fixed location or mobile recording device, a method is needed to associate independent video, audio, and metadata to other video, audio, and metadata related to an Incident on a free form after the fact basis, without having to know in advance to associate the multiple video, audio, and metadata sources. Public Safety and Law Enforcement Incidents are typically not known in advance with any certainty. It is not possible to predict a crime, fire, gas leak, lightning strike, equipment failure, weather, natural disasters, terror events, emotions, or the interactions of various human beings each of whom has free will to act in a variety of behaviors at any given moment. Therefore it is impossible to predict what Law Enforcement, Fire, EMS, and other Incidents will occur, when they will occur, or where they will occur. It is also therefore impossible to predict with any certainty what Law Enforcement, Fire, EMS or other entity staff and assets will become involved or engaged in an

Incident. In many cases staff will be in the vicinity of an Incident, and may capture video, audio, and/or metadata that provides information about the Incident, but the staff themselves are completely unaware that an Incident has occurred or is in progress. A video and audio association method is needed that does not assume prior knowledge of or any prior linking, pairing, or other manual method of associating multiple recording devices in advance of an Incident.

Incidents themselves are often mobile. An Incident may start at one location but then subsequently move in one or more directions, particularly when the Incident involves a vehicle chase with multiple vehicle occupants. Various Law Enforcement vehicles and officers may become engaged in an Incident that changes location as a suspect vehicle flees the initial scene of the Incident. Furthermore, multiple suspect vehicles may be involved in an Incident. Even furthermore, one or more suspect vehicles involved in an Incident may have multiple occupants in a vehicle, and who may abandon the vehicle at some point and depart a scene on foot traveling in multiple directions, each of whom may be followed by one or more different

Law Enforcement officers. Additional Law Enforcement officers may become engaged in the Incident when fleeing suspects are spotted and identified by other Law Enforcement officers who were not originally involved in the Incident, but who may also be wearing personal video recorders (that include cameras) and/or have In-Car Video recorders in their patrol cars that record video, audio, and metadata about what turns out to be part of an overall Incident. Mobile and Fixed location License Plate Recognition systems can also provide real-time vehicle identification and location information. Video and audio recording assets and License Plate Recognition systems that were not within recording range of the Incident at the start of the Incident may become relevant and capture video, audio, and metadata about an Incident as the Incident travels nearby to these formerly un-involved recording and vehicle recognition assets. As an example, a personal camera on a police officer located a mile away from the starting point of an Incident would be unlikely to record any video or audio artifacts that would be relevant to the Incident. However, as a fleeing suspect's vehicle travels towards the police officer, who might be completely unaware that the Incident vehicle is traveling in his or her direction, the personal video camera may be triggered or otherwise record video, audio and/or metadata artifacts that become part of the overall Incident set of facts. In a similar manner, an In-Car Video recording system might also collect video and audio artifacts as a suspect vehicle or suspect fleeing on foot converges with the formerly distant law enforcement vehicle or officer. Furthermore in a similar manner, a fixed location video camera or other sensor device may capture video, audio, and/or metadata artifacts that are relevant to and a part of the total set of facts for an Incident as a suspect vehicle or individual passes by the fixed location video, audio, and/or metadata recording asset.

A method is needed that can analyze multiple metadata artifacts, and with a high degree of accuracy identify all video, audio, and metadata artifacts that might be related to an Incident. Furthermore a method is needed to allow a Video Administrator, Prosecutor, Defense Attorney, Supervisor, Police Officer, or other Video Management system User to pick and choose various video, audio, and/or metadata artifacts from an Incident, and play the chosen video, audio, and/or metadata segments synchronized by time on a parallel side-by-side basis view of video, audio, and metadata artifacts from various combinations and perspectives to understand the facts of what events actually transpired during the course of the Incident. The viewer needs to be able to replay a combination of video and audio artifacts from one or more perspectives to aid legal counsel in presenting the facts of an Incident to a judge or jury. Or replay a combination of artifacts that might be used by a company, government agency, other entity, or by an individual as a training aid, a method to assess storm or accidental damage, equipment failure, identify the exact location of electric or gas line assets that have been buried in a utility trench, or to defend against false claims of deleterious actions and torts that are potentially damaging to an entity such as the city of Ferguson, MO or to an individual such as a police officer who may be accused of wrongful death, inappropriate use of force, violation of civil rights, or other action or slander that could damage or end a career, or result in wrongful conviction of felony charges with subsequent fines, imprisonment, and other legal consequences. There is a need for a method that will associate all video, audio, and metadata sources that are relevant to an Incident so that all sources of fact related to an Incident are identified and available to be considered by all relevant and authorized parties.

### SUMMARY

The invention requires the capture of a variety of metadata artifacts along with video and audio data through a variety of fixed location and mobile video, audio, license plate, and metadata collection devices. Once the metadata artifacts are captured and stored in one or more sets of databases, free form data stores, and other machine readable forms, a variety of metadata analysis algorithms, methods and processes can be used to analyze real-time metadata streams and scan electronic databases to identify and associate various metadata artifacts to identify other video and/or audio artifacts were involved in an Incident. This association of artifacts can be achieved even if the individuals or vehicles with the video, audio, and/or metadata capture devices at the time were not aware that the artifacts were related to the same Incident.

### BRIEF DESCRIPTION OF THE DRAWINGS

FIG. 1 is a schematic view of several police officers wearing personal video recorders/cameras, and a vehicle with one or more video, audio, metadata, and/or license plate recognition (LPR) cameras, microphones, sensors, and scanners.

### DETAILED DESCRIPTION

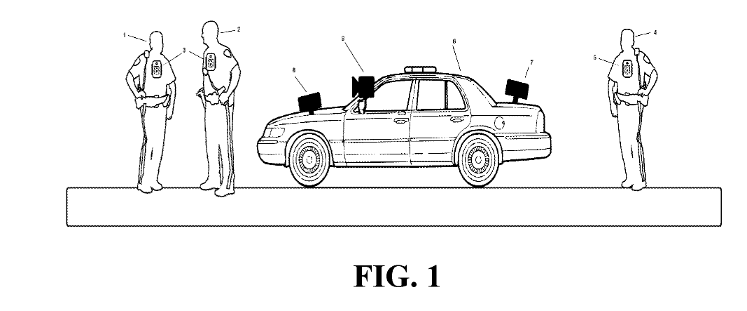

Regarding FIG. 1, the police officers 1 and 2 are wearing personal video recorders/cameras 3 that capture video, audio, and a variety of metadata from embedded sensors and real-time communications interfaces. Other police officers 4 wearing personal video recorders/cameras 5 located significant distances from other officers and/or vehicles are also capturing video, audio, and a variety of metadata from embedded sensors and real-time communications interfaces. In many cases officers 1 and 2 are not aware that officer 4 is in the area or aware that officer 4 may also be engaged in some facet or aspect of the Incident, and vice versa. Therefore there is no knowledge between Incident participants that other video, audio, and metadata artifacts have been captured that might be relevant to understanding the totality of the facts related to a single Incident.

Furthermore, vehicle 6 License Plate Recognition (LPR) systems 7 and 8 and In-Car video, audio, metadata capture systems 9 may also capture data that is also part of the Incident. Metadata analysis algorithms that search date/time, location, LPR, facial recognition, and metadata proximity, people, and asset indicators, indexes, and unstructured text data included in Notes and other free-form fields can identify various video, audio, LPR, and other metadata relationships that associate multiple artifacts to an Incident.

### ADVANTAGES OF THE PRESENT INVENTION

The advantage of the present invention is to provide a means to identify all video, audio, LPR and metadata artifacts that are related to an Incident on a real-time and batch analysis basis. There is no requirement to pre-associate evidence capture devices. Evidence capture devices operate independently. Video, audio, LPR, and metadata evidence is captured, indexed, and stored in a machine-readable format where it can be efficiently and quickly analyzed and processed by software algorithms. The present invention takes advantage of search algorithms and processes to scan a multitude of artifacts, and identify other artifacts that may be related to an Incident. The resulting association of all evidence artifacts related to an Incident or an Event provides a comprehensive and complete understanding of what transpired during the course of an Incident or an Event. This comprehensive fact base can help ensure that justice is served, community tensions can be lowered, exaggerated or unfounded tort and conduct claims can be defended and refuted, officer and field crew safety, security, efficiency and effectiveness can be increased, and Incident and Event “Lessons Learned” and training curricula and support materials can be improved, and Incident and Event policies and procedures can be revised when appropriate so that more optimal and fair outcomes can be achieved in the future.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention. To the extent necessary to understand or complete the disclosure of the present invention, all publications, patents, and patent applications mentioned herein are explicitly incorporated by reference therein to the same extent as though each were individually so incorporated.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

1. A method for capturing and associating incident information, comprising;
Digitally capturing by an electronic device at least two of video, audio or metadata information concerning an incident to have a first recorded information and a second recorded information;
storing said captured information in a data base;
scanning said stored information in said database to identify a plurality of artifacts present in the recorded first information and the recorded second information;
associating said scanned and identified plurality artifacts of said first recorded data with that of said second recorded data, all of which are related to said incident so as to synchronize said first record data set with said second recorded data set.

2. The method of claim 1 wherein step of digitally capturing at least two of video, audo or meta data information includes recording with a personal camera.

3. The method of claim 1 wherein the step of digitally capturing at least two of video, audio or metadata information includes recording with an in-car camera.
